(19) United States
(12) Patent Application Publication
(10) Pub. No.: US 2026/0238910 A1
(43) Pub. Date: Aug. 13, 2026

(54) FILTER INFORMATION DETERMINATION APPARATUS AND METHOD

(71) Applicant: NTT, Inc., Tokyo (JP)

(72) Inventors: Hironobu CHIBA, Musashino-shi, Tokyo (JP); Tatsuya KAKO, Musashino-shi, Tokyo (JP); Hiroaki ITO, Musashino-shi, Tokyo (JP); Kenichi NOGUCHI, Musashino-shi, Tokyo (JP); Shihori KOZUKA, Musashino-shi, Tokyo (JP)

(73) Assignee: NTT, Inc., Tokyo (JP)

(21) Appl. No.: 19/157,715

(22) PCT Filed: Feb. 28, 2023
(86) PCT No.: PCT/JP2023/007336

§ 371 Date: Aug. 19, 2025

(51) Int. Cl. H04R 1/10

(52) U.S. Cl. CPC H04R 1/1016; H04R 2460/07

(57) ABSTRACT

A filter information determination device includes: a filter information storage unit configured to store multiple pieces of filter information for performing filter processing on a signal to be reproduced by a wearable device that reproduces a sound without completely blocking external ear canal; a filter processing unit configured to perform filter processing on a predetermined signal using filter information from the multiple pieces of filter information read from the filter information storage unit to generate a filtered signal; and a filter information selection unit configured to select filter information from the multiple pieces of filter information based on a localization evaluation of sound based on the filtered signal by a user who listens to the sound based on the filtered signal radiated by the wearable device.

### TECHNICAL FIELD

The disclosed technology relates to a technology for determining filter information.

### BACKGROUND ART

Examples of wearable devices that play a sound without completely blocking the external ear canal include open-ear earphones, shoulder speakers, audio glasses, and smart glasses.

Note that “without completely blocking the external ear canal” here means that the sound wave radiating part is not placed in the area on the axis passing through the entrance of ear canal, as shown by a long dashed line in FIG. 1. A sound wave radiating part may be placed in the surrounding area of the helix or earlobe as shown by a dashed line in the same drawing. An example of a device in which the sound wave radiating part is placed in the surrounding area is audio glasses. The sound wave radiating part may also be placed in the area around the triangular fossa, crura of antihelix, and fossa navicularis, as shown by a double-dotted line in the same drawing. An example of a device in which the sound wave radiating part is placed in the area is open-ear earphones.

In a device that has the sound wave radiating part in the areas around the triangular fossa, crura of antihelix, and fossa navicularis, such as open-ear earphones, it is known that if an inverse filter that cancels out HeSTF (transfer function from a speaker to the entrance of the ear canal) is applied, reproduced sound will be localized in the center of the head, just like conventional earphones, and if the HeSTF inverse filter is not applied, the sound will be localized upward (see FIG. 2). Further, in a case where a HeSTF inverse filter is not applied to the device that has sound wave radiating part in the areas around the triangular fossa, crura of antihelix, and fossa navicularis, such as open-ear earphones, the reproduced sound is generally localized above and inside the head, but this varies from person to person, and the reproduced sound may be localized above and outside the head for some people.

The definition of HeSTF in a frequency domain is shown in the following equation:

$${Y}_{L} ( ω ) = {H}_{HeSTF} ( ω , {p}_{L} , {u}_{L} , {v}_{L} ) {X}_{L} ( ω ) \qquad [ Math . 1 ]$$

$${Y}_{R} ( ω ) = {H}_{HeSTF} ( ω , {p}_{R} , {u}_{R} , {v}_{R} ) {X}_{R} ( ω )$$

wherein X denotes a reproduction signal, Y denotes a signal at the eardrum/ear canal entrance, p denotes a position of a sound source, u denotes the shape of an earphone, and v denotes a user's ear shape. HeSTF is disclosed in, for example, NPL 1.

### CITATION LIST

### Non Patent Literature

[NPL 1]R. Gupta et al., “Augmented/Mixed Reality Audio for Hearables: Sensing, control, and rendering”, in IEEE Signal Processing Magazine, vol. 39, no. 3, pp. 63-89, May 2022.

### SUMMARY OF INVENTION

### Technical Problem

However, no technology has been proposed to date for selecting a filter, such as an HeSTF inverse filter, that is appropriate for each user.

The disclosed technology aims to provide a filter information determination device and a method that determines filter information appropriate for each user.

### Solution to Problem

A filter information determination device according to one aspect of the disclosed technology includes: a filter information storage unit configured to store multiple pieces of filter information for performing filter processing on a signal to be reproduced by a wearable device that reproduces a sound without completely blocking external ear canal; a filter processing unit configured to perform filter processing on a predetermined signal using filter information from the multiple pieces of filter information read from the filter information storage unit to generate a filtered signal; and a filter information selection unit configured to select filter information from the multiple pieces of filter information based on a localization evaluation of sound based on the filtered signal by a user who listens to the sound based on the filtered signal radiated by the wearable device.

### Advantageous Effects of Invention

The disclosed technology makes it possible to determine filter information appropriate for each user.

### BRIEF DESCRIPTION OF DRAWINGS

FIG. 1 is a diagram illustrating a position of a sound wave radiating part in a wearable device that reproduces a sound without completely blocking the external ear canal.

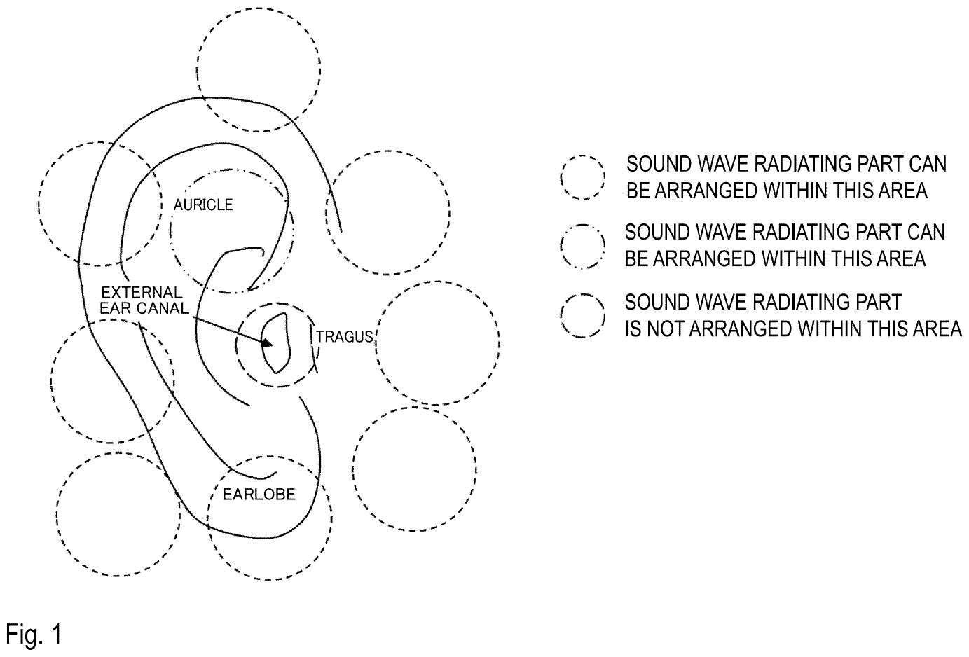

FIG. 2 is a diagram illustrating a comparison between localization of reproduced sound from conventional earphones and localization of reproduced sound from open-ear earphones before applying an inverse filter.

FIG. 3 is a diagram illustrating an example of a functional configuration of a filter information determination device.

FIG. 4 is a diagram illustrating an example of a processing procedure of a filter information determination method.

FIG. 5 is diagram illustrating a user's posture.

FIG. 6 is a diagram illustrating a functional configuration example of a computer.

### DESCRIPTION OF EMBODIMENTS

Hereinafter, an embodiment of the disclosed technology will be described with reference to the drawings. Further, components with the same function are denoted by the same reference numerals in the drawings, and redundant explanations are omitted accordingly.

### [Filter Information Determination Device and Method]

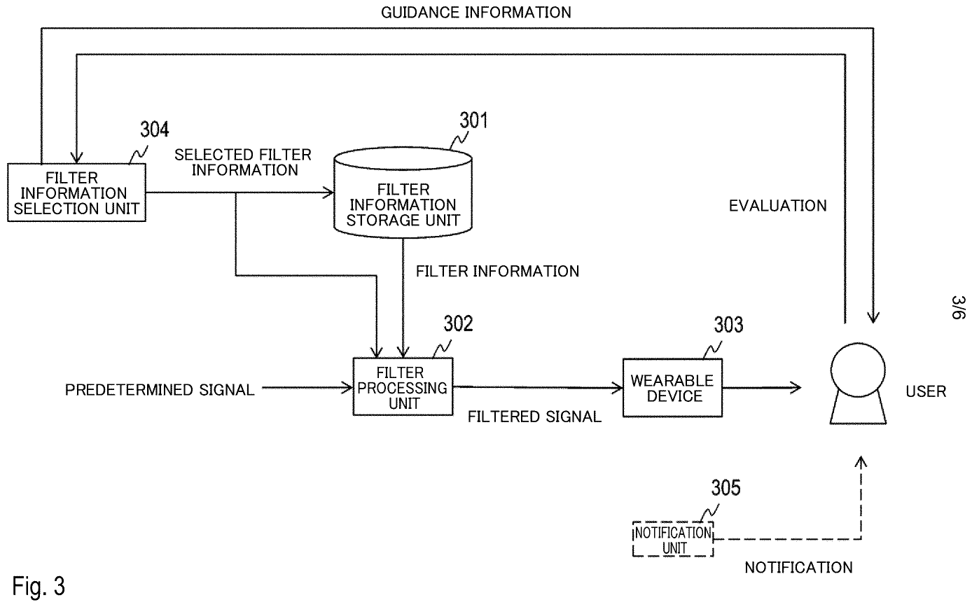

As shown in FIG. 3, a filter information determination device includes, for example, a filter information storage unit 301, a filter processing unit 302, and a filter information selection unit 304. The filter information determination device may further include a wearable device 303.

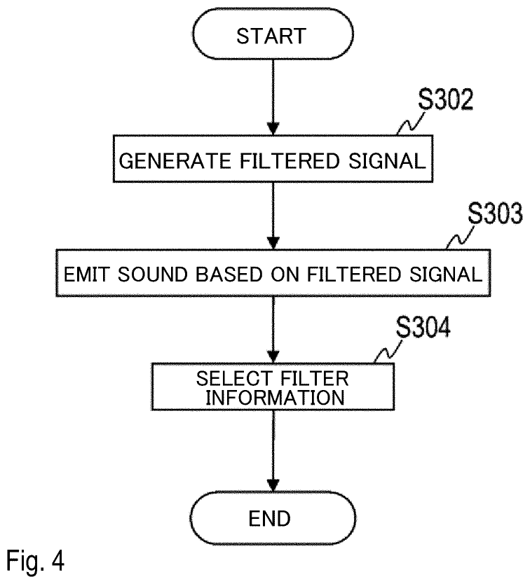

A filter information determination method is implemented, for example, by each component of the filter information determination device performing processes of steps S302 to S304 described below and shown in FIG. 4.

Each component of the filter information determination device is described below.

### <Filter Information Storage Unit 301>

The filter information storage unit 301 stores multiple pieces of filter information for filtering signals to be reproduced by a wearable device that reproduces a sound without completely blocking the ear canal.

The filter information is information for determining a time-domain or frequency-domain filter. The filter information may be the filter itself.

The filter information is, for example, information about a filter for canceling out at least one of housing position characteristics of the wearable device and characteristics due to the user's ear shape.

For example, the filter information is an HeSTF inverse filter. The filter information may be an HeSTF filter, an approximation filter of the HeSTF inverse filter, or a filter coefficient of the approximation filter of the HeSTF inverse filter. The filter information may also be parameters for determining the filter coefficient of the approximation filter of the HeSTF inverse filter. When the approximation filter of the HeSTF inverse filter is peaking EQ, exemplified parameters for determining the filter coefficient of the approximation filter of the HeSTF inverse filter are frequency, gain, and Q value.

The filter information may be information about a filter other than the filters exemplified above.

### <Filter Processing Unit 302>

A predetermined signal is input to the filter processing unit 302.

The multiple pieces of filter information read from the filter information storage unit 301 are input to the filter processing unit 302.

The filter processing unit 302 performs filter processing on the predetermined signal using filter information from among the multiple pieces of filter information read from the filter information storage unit 301, and generates a filtered signal (step S302).

The generated filtered signal is output to the wearable device 303.

To evaluate whether it is effective for binaural reproduction, the predetermined signal may be a signal to which a filter approximating a head-related transfer function (HRTF) has been applied.

### <Wearable Device 303>

The filtered signal generated by the filter processing unit 302 is input to the wearable device 303.

The wearable device 303 is a device that reproduces a sound without completely blocking the external ear canal. The wearable device 303 is, for example, open-ear earphones, a shoulder speaker, audio glasses, or smart glasses.

The wearable device 303 radiates a sound based on the filtered signal (step S303).

A user wearing the wearable device 303 listens to the sound radiated by the wearable device 303.

The user evaluates localization of the sound based on the filtered signal that they have listened. Evaluation is output to the filter information selection unit 304, which will be described later.

Guidance information encouraging the evaluation may be presented to the user from the filter information selection unit 304.

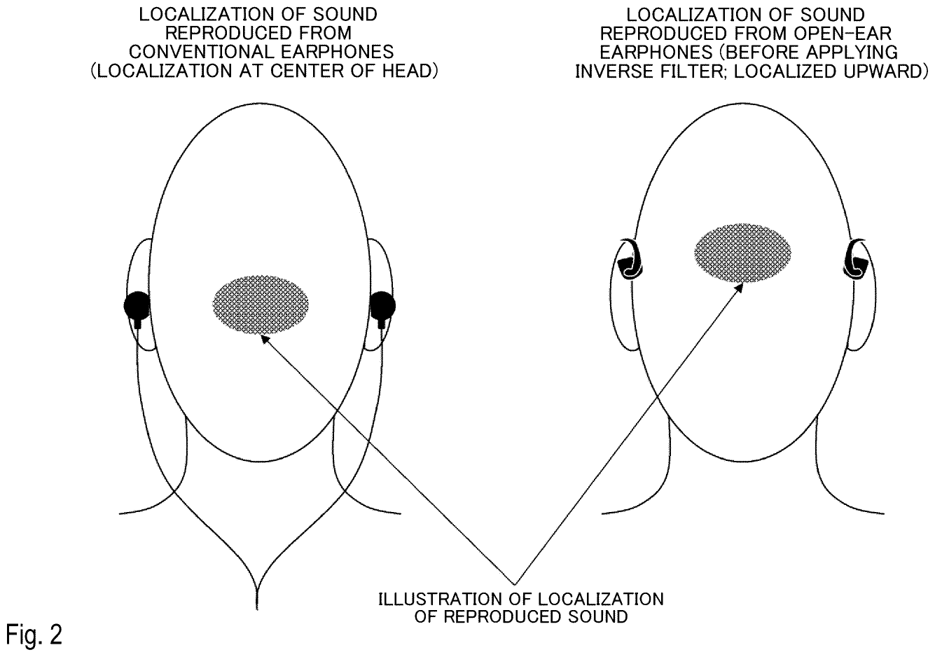

As described in “Background Art”, in a device that has the sound wave radiating part in the areas around the triangular fossa, crura of antihelix, and fossa navicularis, such as open-ear earphones, it is known that if an inverse filter that cancels out HeSTF (transfer function from a speaker to the entrance of the ear canal) is applied, reproduced sound will be localized in the center of the head, just like conventional earphones, and if the HeSTF inverse filter is not applied, the sound will be localized upward (see FIG. 2).

Following is an example of guidance information for determining an appropriate HeSTF inverse filter.

An example of the guidance information is a voice guidance: “From these sound sources, please select the one that is localized at the same height as the ear canal”. When this voice is presented to the user, the user operates an information processing device such as a smartphone, tablet terminal, or PC (not shown) to select the one that is localized at the same height as the ear canal, and the selection result is input to the filter information selection unit 304 as an evaluation of the sound localization based on the filtered signal.

Another example of guidance information is a voice asking “How has the height of the other sound source changed compared to the sound source without the inverse filter?” and options asking about a specific location, such as “No Change/Localized between above the Ear Canal and the Wearable Device 303/Localized around the Ear Canal/Localized below the Ear Canal” displayed on a screen of the information processing device such as a smartphone, tablet terminal, or PC (not shown). Options displayed on the screen of the information processing device such as a smartphone, tablet terminal, or PC (not shown) may be relative options such as “Higher/No Change/Lower”.

When the voice and options are presented to the user, the user operates the information processing device such as a smartphone, tablet terminal, or PC (not shown) to select any of the options, and the selection result is input to the filter information selection unit 304 as an evaluation of the sound localization based on the filtered signal.

### <Filter Information Selection Unit 304>

The filter information selection unit 304 receives an evaluation of the sound localization based on the filtered signal from the user who has listened to the sound based on the filtered signal radiated by the wearable device.

The filter information selection unit 304 selects filter information among the multiple pieces of filter information based on the evaluation of the sound localization based on the filtered signal from the user who has listened to the sound based on the filtered signal radiated by the wearable device (step S304).

The selected filter information is output to the filter information storage unit 301 and the filter processing unit 302. The filter processing unit 302 uses the selected filter information to perform filter processing on the signal to be reproduced and generates the filtered signal. The generated filtered signal is output to the wearable device 303. The wearable device 303 radiates a sound based on the filtered signal.

As described above, the filter information appropriate for each user can be determined by selecting filter information among the multiple pieces of filter information based on the evaluation of the sound localization based on the filtered signal from the user who has listened to the sound based on the filtered signal radiated by the wearable device.

The filter information selection unit 304 may use, for example, a tournament-like evaluation as described in Reference 1. For example, the filter information selection unit 304 may select filter information using the following (1) and (2).
(1) The user is asked to evaluate sounds based on two filtered signals corresponding to two different pieces of filter information, and the filter information with the higher evaluation is selected.
(2) The above selection (1) is performed in a tournament format for multiple pieces of filter information, and the above selection (1) is repeated until the one piece of filter information with the highest evaluation remains.
[Reference 1] Koji Saito, Yukio Iwaya, Yoichi Suzuki, “Sound Localization with Individualized HRTF Selected by Tournament Matches”, Proceedings of the 4th Forum on Information Technology, FIT2005, 2005

### MODIFIED EXAMPLES

As described above, the specific configuration of the embodiment of the disclosed technology is not limited to the configuration described so far. The specific configuration of the embodiment of the disclosed technology can be modified in design appropriately without departing from the gist of the disclosed technology.

The various types of processing described in the embodiment of the disclosed technology are not limited to being executed in a time-series manner in the described order, and may be executed in parallel or individually in accordance with the processing capability of the device that executes the processing or as required.

For example, data may be directly exchanged across the components of the filter information determination device or may be exchanged via a storage unit (not illustrated).

The filter information determination device may include a notification unit 305 shown by a broken line in FIG. 3. When the user is making an evaluation, if the user's posture does not allow the user to make a correct evaluation, the notification unit 305 notifies the user of wrong posture.

Depending on the user's posture, the localization and direction may vary, making it impossible to perform an accurate evaluation. If the user's posture does not allow for an accurate evaluation, the user is notified of their wrong posture, allowing the user to perform a correct evaluation and determine more appropriate filter information.

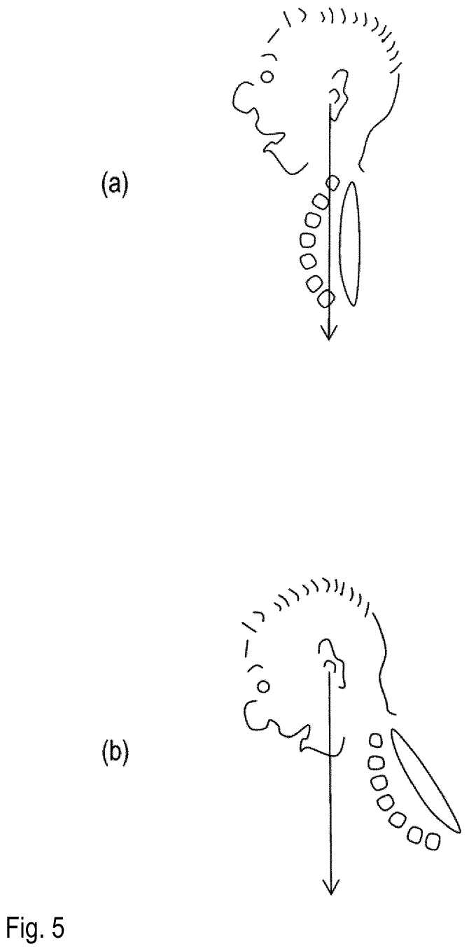

An example of a posture in which the evaluation can be performed correctly is a posture in which the user looks down, as shown in FIG. 5(a). On the other hand, an example of a posture in which the evaluation cannot be performed correctly is a posture in which the user looks down, as shown in FIG. 5(b).

An example of the notification may be a voice notification saying “Please correct your posture”, or a visual notification such as text, image, or video saying “Please correct your posture” displayed on the screen of the information processing device such as a smartphone, tablet device, or PC (not shown).

For example, if the information processing device such as a smartphone, tablet terminal, or PC held by the user or the wearable device worn by the user is provided with an acceleration sensor, the notification unit 305 may estimate the user's posture from the acceleration sensor and determine whether or not the user's posture disturbs a correct evaluation. For example, if the user's posture estimated from the acceleration sensor is a posture that the user faces downward or upward beyond a predetermined angle, the notification unit 305 may determine that the user's posture disturbs a correct evaluation.

If it is determined that a correct evaluation cannot be performed due to the user's posture, the filter information determination device may prevent the user from performing an evaluation.

Furthermore, the filter information storage unit 401 may store ear shape information, which is information about the ear shape of each user from whom the filter information is obtained. Multiple pieces of ear shape information for each user may be stored in the filter information storage unit 401. The multiple pieces of ear shape information for each user are, for example, multiple pieces of ear shape information when each user wears the wearable device in multiple different positions.

The filter information storage unit 401 may store filter information measured using a dummy head or an ear model that replicates an average ear shape.

### [Program and Recording Medium]

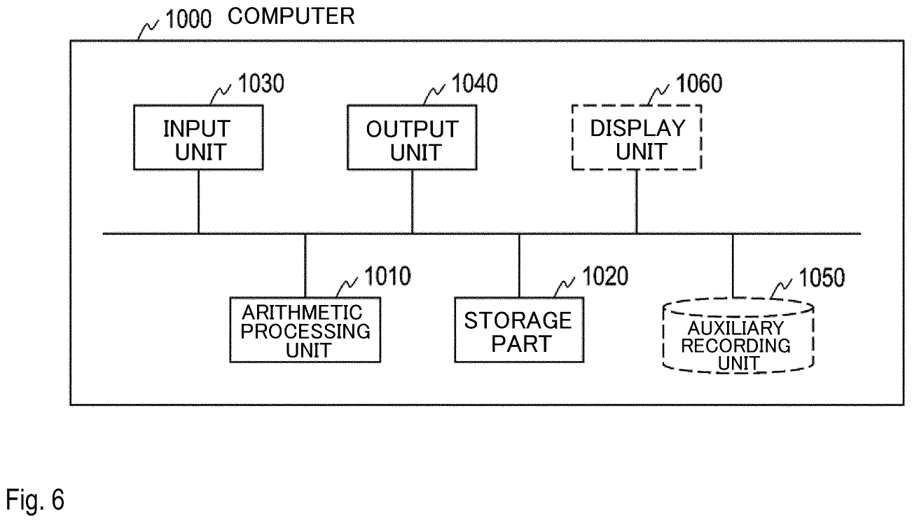

The processing of each unit in the filter information determination device described above may be implemented by a computer, and in this case, detailed processing of the functions that is supposed to be included in the filter information determination device is described by a program. The program is read by a storage unit 1020 of a computer 1000 shown in FIG. 6 to operate an arithmetic processing unit 1010, an input unit 1030, an output unit 1040, and a display unit 1060, thereby implementing various types of processing functions in the filter information determination device on the computer.

The program describing the detailed processing can be recorded on a computer-readable recording medium. The computer-readable recording medium is, for example, a non-transitory recording medium, and specifically a magnetic recording device, or an optical disc.

Further, the program is distributed, for example, through sales, transfer, or rent of a portable recording medium such as a DVD or a CD-ROM on which the program is recorded. The program may be distributed by storing the program in advance in a storage device of a server computer and transferring the program from the server computer to another computer via a network.

The computer executing such a program first temporarily stores the program recorded in the portable recording medium or the program transferred from the server computer, for example, in an auxiliary recording unit 1050, which is its own non-transitory storage device. The computer reads the program stored in the auxiliary recording unit 1050 serving as its own non-transitory storage device onto the storage unit 1020, and executes the processing according to the read program. As another embodiment of executing the program, the computer may read the program directly from the portable recording medium onto the storage unit 1020, and execute the processing according to the program, or alternatively, the computer may sequentially execute the processing according to the program received from the server computer every time the program is transferred from the server computer. Moreover, the processing may be executed by a so-called application service provider (ASP) service that implements a processing function only by an execution instruction and result acquisition without transferring the program from the server computer to the computer. Note that the program in the present embodiment includes information that is used for processing by an electronic computer and is equivalent to the program (for example, data that is not a direct command for the computer but has a property that defines processing performed by the computer).

Additionally, although the device is configured by executing the predetermined program on the computer in this embodiment, at least part of the processing may be implemented by hardware. For example, the filter processing unit 302, the filter information selection unit 304, and the notification unit 305 may be configured by a processing circuit.

Alterations or modifications can be made as appropriate without departing from the gist of the present invention.

All literatures, patent applications, and technical standards described herein are incorporated herein by reference to the same extent as when each individual publication, patent application and technical standard are specifically and individually described as being incorporated by reference.

1. A filter information determination device comprising processing circuitry configured to:
store multiple pieces of filter information for performing filter processing on a signal to be reproduced by a wearable device that reproduces a sound without completely blocking external ear canal;
perform filter processing on a predetermined signal using filter information from the multiple pieces of filter information read to generate a filtered signal; and
select filter information from the multiple pieces of filter information based on a localization evaluation of sound based on the filtered signal by a user who listens to the sound based on the filtered signal radiated by the wearable device.

2. The filter information determination device according to claim 1, wherein the filter information is information about a filter for canceling out at least one of housing position characteristics of the wearable device and characteristics due to the user's ear shape.

3. The filter information determination device according to claim 1, processing circuitry further configured to:
notify the user when the user's posture is such that the evaluation cannot be performed correctly.

4. A filter information determination method, performed in a device comprising a filter information memory storing multiple pieces of filter information for performing filter processing on a signal to be reproduced by a wearable device that reproduces a sound without completely blocking external ear canal, the filter information determination method comprising:
performing filter processing on a predetermined signal using filter information from the multiple pieces of filter information read from the filter information memory to generate a filtered signal; and
selecting filter information from the multiple pieces of filter information based on a localization evaluation of sound based on the filtered signal by a user who listens to the sound based on the filtered signal radiated by the wearable device.
